(19) United States
(12) Patent Application Publication
(10) Pub. No.: US 2017/0225968 A1
(43) Pub. Date: Aug. 10, 2017

(54) Filter media for removal of Arsenic from Potable Water with iron-impregnated activated carbon enhanced with titanium oxide

(71) Applicant: Graver Technologies LLC, Glasgow, DE (US)

(72) Inventors: Vivekanand Gaur, Bangalore (IN); Ramachandra Swamy, Bangalore (IN); James Knoll, Glenn Gardner, NJ (US)

(21) Appl. No.: 15/087,105

(22) Filed: Mar. 31, 2016

(30) Foreign Application Priority Data
Feb. 4, 2016 (IN) 201621004023

(51) Int. Cl. C02F 1/28; B01J 20/32; B01J 20/02; B01J 20/20; B01J 20/06

(52) U.S. Cl. CPC C02F 1/283; C02F 1/286; C02F 1/281; C02F 1/288; B01J 20/20; B01J 20/06; B01J 20/0229; B01J 20/027; B01J 20/3236; B01J 20/3204; C02F 2101/103

(57) ABSTRACT

A filter media for the filtration of potable water; specifically, for the removal of arsenic from potable water using iron-impregnated activated carbon enhanced with titanium oxide, such as the titanium oxide mixture used in the commercial product Metsorb®. The activated carbon is subjected to a wet impregnation process using an iron salt solution of approximately 6% of iron(III) chloride FeCl₃ solution and 1.25% of NaOH solution.

### BACKGROUND OF THE INVENTION

1. Field of the Invention

The present invention relates to a filter media for the filtration of potable water; specifically, to the removal of arsenic from potable water using iron-impregnated activated carbon enhanced with titanium oxide, such as the titanium oxide mixture used in the commercial product Metsorb®.

2. Description of Related Art

Arsenic (As) is introduced into soil and groundwater during weathering of rocks and minerals followed by subsequent leaching and runoff. It can also be introduced into soil and groundwater from anthropogenic sources. Many factors control arsenic concentration and transport in groundwater, which include: adsorption/desorption, precipitation/dissolution, Arsenic speciation, pH, presence and concentration of competing ions, and/or biological transformation, among other factors. The adsorption and desorption reactions, arsenic species, pH, solid-phase dissolutions, and precipitations may vary from aquifer to aquifer that depend upon the geological settings.

The introduction of Arsenic is not only a problem in the United States; it is also a health concern in other countries as well. For example, in India, since the groundwater arsenic contamination first surfaced from West-Bengal in 1983, a number of other India States, namely: Jharkhand, Bihar, and Uttar Pradesh in flood plain of the Ganga River; Assam and Manipur in flood plain of the Brahmaputra and Imphal rivers; Rajnandgaon village in Chhattisgarh state; have chronically been exposed to drinking arsenic contaminated hand tube-wells water above the India permissible limit of 50 μg/L. Many more North-Eastern India Hill States in the flood plains are also suspected to have the possibility of arsenic in groundwater. With every additional survey reported new arsenic affected villages are identified in India, and the inhabitants thereof suffer from arsenic related diseases. All the arsenic affected river plains have river routes originated from the Himalayan region. Whether or not the source material has any bearing on the outcrops is a matter of research, however, over the years, the problem of groundwater arsenic contamination has been complicated, to a large variability at both the local and regional scale, by a number of unknown factors.

Arsenic groundwater contamination has far-reaching consequences including its ingestion through the food chain, which may be accounted for in the form of social disorders, health hazards, and socioeconomic dissolution, besides its sprawling with movement and exploitation of groundwater. Additionally, it remains possible for food crops grown using arsenic contaminated water to be sold off to other places, including uncontaminated regions where the inhabitants may consume arsenic from the contaminated food. This may give rise to a new danger.

Arsenic in drinking water can cause chronic arsenic intoxication (arsenicosis), which may lead to harm of respiratory, digestive, renal circulatory, neural systems, and internal organs. There are reported clinical effects and symptoms including Raynaud's syndrome, hypertension, cerebral infarction (Chen, et al., “A Comparison of the Effects of a Sodium Channel Blocker and an NMDA Antagonist Upon Extracellular Glutamate in Rat Focal Cerebral Ischemic,” Brain Research, Volume 699, Issue 1, 13 Nov. 1995, pp. 121-124), encephalopathy, damage of the peripheral nerve bodies (Bansal, et al., “Transesophageal Echocardiography,” Current Problems in Cardiology, Volume 15, Issue 11, November 1990, pp. 646-720), diabetes mellitus (Lai, et al., “Molecular Genetics of WIC Class II Alleles in Chinese Patients with IgA Nephropathy,” Kidney International, Volume 46, Issue 1, July 1994, pp. 185-190), and circulatory disorders. In large regions of Bangladesh and West Benghal, India, the drinking water contains arsenic concentrations as high as 1 mg/L; and as many as 50-65 million people are being poisoned by this. In this area, 170,000 people have exhibited symptoms of chronic arsenicosis (Das, et al., “Metal Speciation in Solid Matrices,” Talanta, Volume 42, Issue 8, August 1995, pp. 1007-1030).

The most significant consequence of chronic arsenic intoxication is the induction of cancers in various organs. Consequently, arsenic has been recognized as a Class 1 human carcinogen, and is a public concern due to its widespread usage in both industry and agriculture. An area in Taiwan has had drinking water sources in which arsenic concentrations ranged from 170 to 800 ppb. On the basis of the cancer that was observed that a 50 ppb arsenic level would translate to a lifetime risk that 13 people per 1000 could die from cancer to the liver, lung, kidney, or bladder (Smith, et al., “Clinicopathologic Study of Arsenic-Induced Skin Lesions: No Definite Association with Human Papillomavirus,” Journal of the American Academy of Dermatology, Volume 27, Issue 1, July 1992, pp. 120-122). Arsenic also causes skin cancer at low concentrations, and it poisons the heart and gastrointestinal tract at high concentrations.

Inorganic arsenic in low and micro-molar doses can cause genotoxicity. Researchers have reported that sodium arsenite (NaAsO₂) can induce chromosome aberrations, sister Chromatic exchanges, and DNA-protein crosslinks (Dong, et al., “Arsenic-Induced DNA-strand Breaks Associated with DNA-protein Crosslinks in Human Fetal Lung Fibroblasts,” Mutation Research Letters, Volume 302, Issue 2, June 1993, pp. 97-102.

In early 2001, the Environmental Protection Agency of the United States published a revised arsenic standard of 10 ppb in drinking water. This is considerably lower than the previous 50 ppb standard, which was established in 1942. Hence, there is great need to devise new and innovative technologies that are inexpensive to use, easy to operate, and durable through long-term use, to remove arsenic from potable water.

### SUMMARY OF THE INVENTION

Bearing in mind the problems and deficiencies of the prior art, it is therefore an object of the present invention to provide a filter media for effective removal of arsenic from potable water.

The above and other objects, which will be apparent to those skilled in the art, are achieved in the present invention which is directed to a method of making a filter media for removing arsenic from water, the method comprising: impregnating activated carbon with iron; blending the activated carbon with titanium (IV) oxide; and forming a filter media block of the iron-impregnated activated carbon blended with titanium (IV) oxide.

The impregnating step includes modifying the surface of the activated carbon using a wet impregnation process with an iron salt solution.

The method further includes preparing the iron salt solution by dissolving ferric chloride anhydrous FeCl₃ and NaOH in deionized water; and treating the activated carbon with the iron salt solution.

Preferably, the activated carbon comprises a moisture content less than about 5% and iodine of greater than 1000 mg/g, and includes coconut shell based carbon.

The activated carbon is pulverized using ASTM standard sieves in the range of 40×140 mesh.

Preferably, the iron salt solution includes approximately 6% of iron(III) chloride FeCl₃ solution and 1.25% of NaOH solution.

The titanium (IV) oxide may consist of the commercial product Metsorb®.

The step of blending the activated carbon with titanium (IV) oxide includes blending with about 30% titanium oxide.

The iron impregnated activated carbon is then cooled to about room temperature

In a second aspect, the present invention is directed to a filter media for removing arsenic (As) from water comprising: activated carbon impregnated with iron; and titanium oxide.

The activated carbon includes coconut shell based carbon. The activated carbon is screened using ASTM standard sieves with a particle size range of 40×140 US mesh.

The iron-impregnated activated carbon is surface modified using 6% iron(III) chloride (FeCl₃) solution, and titanium oxide consists of the commercial product Metsorb®.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 depicts a comparative graph of As(V) reduction using iron impregnated activated carbon blocks, some of which were combined with Metsorb®.

### DESCRIPTION OF THE PREFERRED EMBODIMENT(S)

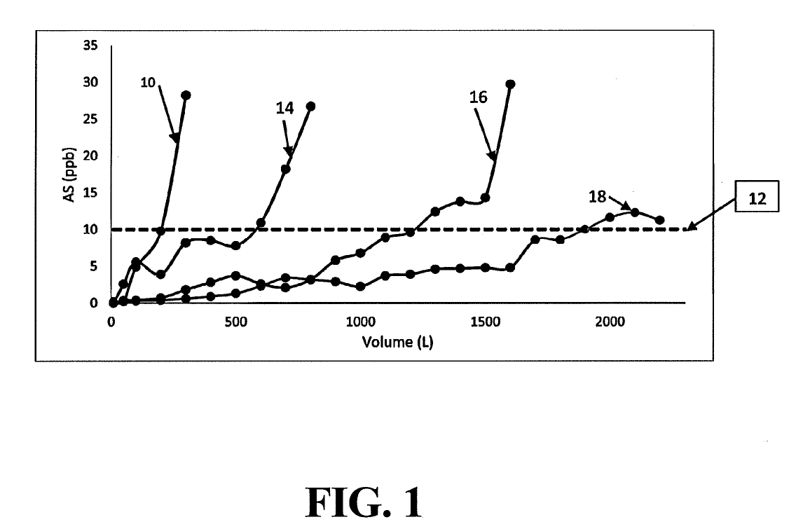

In describing the preferred embodiment of the present invention, reference will be made herein to FIG. 1 of the drawings in which like numerals refer to like features of the invention.

The present invention investigates the removal efficiency of arsenic (As) from water by employing iron-impregnated activated carbon (Fe-AC). The surface modification of the activated carbon, which preferably is coconut shell based, using of 6% iron(III) chloride (FeCl₃) solution, was carried out by a wet impregnation method. The required activated carbon was screened using ASTM standard sieves with a particle size range of 40×140 US mesh.

The adsorption experiments were carried out with an input of 50 μg/L arsenate. The efficacy of the removal efficiency was studied. The modified carbon is preferably blended with different proportions of Titanium (IV) Oxide (TiO₂), such as Metsorb®, for developing more efficient reduction of the same. Metsorb® is made by Graver Technologies, LLC of Glasgow, Del. It is an arsenic, lead, and heavy metal adsorbent media. Metsorb® has been tested using empty bed contact times as low as 10 seconds, and still achieve high removal efficiencies. The material affords a higher capacity and a lower level of ion interference than competitive iron and alumina based products.

The Metsorb® adsorbent is a free-flowing powder designed for incorporation into pressed or extruded carbon blocks. The addition of Graver's Metsorb® at relatively low levels to a carbon block design is very effective for the reduction of lead, and at higher usage levels effective for reduction of arsenic, to meet the requirements of the U.S. NSF Standard 53. Metsorb® utilizes a material to adsorb not only cationic lead species, but also both forms of Arsenic: Arsenic III and Arsenic V, present as (neutral) arsenite and (anionic) arsenate respectively.

Metsorb® will also reduce a wide range of other metal contaminants commonly present in drinking water or process water, and is effective in polishing low levels of metal contaminants from industrial waste streams.

As a fine powder, the addition of Metsorb® is recommended as a component of pressed or extruded carbon blocks, where heavy metal reduction is desired. In blending Metsorb® with carbon and poly binder components, one must assure that both the starting mechanical blend and the unfinished block produced appear homogeneous.

A nominal 10-inch carbon block, standard for most counter-top and under counter applications will provide more overall volume and more functional media than the 2 to 2½ inch blocks typically used in end-of-tap (EOT) or point-of-use (POU) applications. For example, a nominal 10-inch carbon block can easily perform for 1000 gallons or more of contaminant reduction, while the smaller EOT blocks are rated at several hundred gallons.

The larger block design also gives longer contact times, Empty Bed Contact Time (EBCT) for better contaminant reduction. For example, a nominal 10-inch block will provide an EBCT of 10-15 seconds, while a typical 2½ inch EOT block gives only 3 seconds EBCT.

Devices designed for slower flow rates, e.g., 0.5 gpm (gallons per minute) versus 1.0 gpm, will provide longer contact times and better percentage contaminant reduction. Metsorb® media's adsorptive capacity is 7-12 grams of arsenic per kilogram of adsorbent in drinking water applications with a pH range of 6.5-8.5. Much higher adsorptive capacities have been measured, up to 400 g/kg, in industrial treatment applications.

Use of higher concentrations of Metsorb® will also improve heavy metal reduction efficiencies.

Significantly, it has been shown that the Metsorb® adsorbent is safe. Metsorb® adsorbent is certified and listed under the ANSI/NSF Standard 42 as a component of drinking water systems.

The addition of Metsorb® has shown that removal of heavy metals to meet drinking water standards can be achieved without adding contaminants. The high adsorbent capacity requires less frequent cartridge handling and replacement. The adsorbent will not “avalanche” lead or other contaminants. Spent cartridges have been determined to be non-hazardous, and can typically be disposed of in a sanitary landfill as non-hazardous solid waste.

The results showed that the iron modified carbon blended with 30% Metsorb® (i.e., filtration media 70% activated carbon impregnated with iron, and 30% Metsorb®, by weight) was able to achieve the significantly higher capacity as compared to that by individual Fe-AC or Metsorb® alone. The same formulation of the carbon and Metsorb® is used to make a solid block carbon filter, and tested for arsenic and lead reduction in the water stream. The results indicated that the impregnated iron activated carbon treated with Metsorb® is one of the suitable adsorbents which can be used for the removal of arsenic and other metal contaminated waters for point-of-use (POU) drinking water systems.

All of the chemicals used for the testing solutions were reagent grade and were used without further purification. The water used in solutions was distilled water. A stock solution of 1000 mg/L As(V) is prepared by dissolving disodium hydrogen arsenate heptahydrate Na2(HAsO₄).7H₂0 in tap water. As(V) intermediate solutions (100 mg/L) are prepared by diluting the stock solutions with deionized water. Finally, 50 μg/L As(V) spiked water are prepared from the intermediate solution. The pH is measured, in the current instance using a Eutech pH meter (pH 700). The iron salt solution used for impregnation/coating of the activated carbon is prepared by dissolving ferric chloride anhydrous FeCl₃ and NaOH (as obtained, for example, from the Merck Company although other sources may be utilized) in deionized water.

### Preparation of Fe-AC

The fresh activated carbon with moisture less than 5% and iodine of greater than 1000 mg/g is used as the base material. The activated carbon is pulverized using ASTM standard sieves in the range of 40×140 mesh (ASTM, 2007). Surface modification of the activated carbon with iron chloride is carried out by impregnation method using 6% FeCl₃ solution and 1.25% of NaOH solution.

The activated carbon powder is stirred thoroughly with the iron chloride solution to obtain a uniform mixture. The solid to liquid ratio is preferably about 1:3, and the suspension temperature is approximately room temperature. After about one hour of constant stirring, the suspension is filtered and washed with deionized water to remove unbounded iron. The modified mixture is then dried at 100° C. for period of approximately 12 hours.

The iron impregnated activated carbon is then cooled to room temperature and tested for its efficiency in terms of As(V) removal. The iron impregnated carbon is next blended with Metsorb®, a commercially available arsenic scavenger in different proportions for testing purposes and efficacy verification, and the results were compared.

### Results

The surface modified carbon blended with Metsorb® was tested for Arsenic (V) and Lead reduction for gravity system to check for higher adsorption capacity of heavy metals. This carbon was characterized for surface area by BET specific surface area evaluation by nitrogen multilayer adsorption, pore size distribution, morphology studied by scanning electron microscopy (SEM), and crystalline phase x-ray diffraction (XRD).

FIG. 1 depicts a comparative graph of As(V) reduction using iron impregnated activated carbon blocks, some of which were combined with Metsorb®. The performance was tested for different weights of the block ranging from between 104 g to 190 g. The input for As(V), measured at 50 ppb, was prepared in accordance with NSF 53 protocol. The flow rate for the testing was maintained at about 6 liters per hour.

The first test utilized an iron impregnated activated carbon block (Fe-AC) of 104 g without Metsorb®, the results of which are indicated by line 10. The effluent reached the 10 ppb arsenic threshold level as indicated by line 12 at about 200 liters volume and continued to acquire arsenic at a very fast rate over a much short effluent volume interval. At approximately 300 liters, the arsenic level was on the order of 30 ppb.

In contrast, an iron impregnated activated carbon block of the same mass (104 g) was blended with 30% Metsorb®, and showed significant improvement, as depicted by line 14. The 10 ppb arsenic threshold of line 12 was surpassed after the effluent volume reached about 600 liters. After exceeding the 10 ppb threshold, the climb to 30 ppb enjoyed a lower slope than that of the untreated iron impregnated activated carbon block of line 10. The Metsorb® treated impregnated iron, activated carbon block reached the 30 ppb range at approximately 800 liters.

As the weight of the blocks increased to 144 and 190 g the performance of the block increased. to 1200 liters and 1900 liters respectively at the 10 ppb threshold. Line 16 depicts the performance of iron impregnated active carbon blended with 30% Metsorb® in a carbon block mass of 144 g. There was a substantial peak in arsenic after the threshold was exceeded; however, 30 ppb of arsenic was not reached until a volume greater than 1600 liters was realized.

Line 18 depicts the performance of iron impregnated activated carbon blended with 30% Metsorb® in a carbon block mass of 190 g. The media allowed a volume of 1900 liters to pass at or below the arsenic threshold level of 10 ppb, and no substantial peak was observed after the 10 ppb threshold was reached. At approximately 2200 liters a peak of about 13 ppb was measured.

From the results it can be seen that a 30% blend of Metsorb® with the iron impregnated activated carbon showed higher adsorption capacity for Arsenic V and able to achieve a 2000 L lifetime claim for the gravity blocks having a mass of about 190 g.

Similar results were obtained for the reduction of combined As (V+III).

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A method of making a filter media for removing arsenic from water, said method comprising:
impregnating activated carbon with iron;
blending said activated carbon with titanium (IV) oxide; and
forming a filter media block of said iron-impregnated activated carbon blended with titanium (IV) oxide.

2. The method of claim 1 wherein said impregnating step includes modifying the surface of said activated carbon using a wet impregnation process with an iron salt solution.

3. The method of claim 2 including:
preparing said iron salt solution by dissolving ferric chloride anhydrous FeCl₃ and NaOH in deionized water; and
treating said activated carbon with said iron salt solution.

4. The method of claim 1 wherein said activated carbon comprises a moisture content less than about 5% and iodine of greater than 1000 mg/g, and includes coconut shell based carbon.

5. The method of claim 3 including pulverizing said activated carbon using ASTM standard sieves in the range of 40×140 mesh.

6. The method of claim 3 wherein said iron salt solution includes approximately 6% of iron(III) chloride FeCl₃ solution and 1.25% of NaOH solution.

7. The method of claim 1 wherein said titanium (IV) oxide consists of the commercial product Metsorb®.

8. The method of claim 1 wherein said step of blending said activated carbon with titanium (IV) oxide includes blending with about 30% titanium oxide.

9. The method of claim 3 including cooling said iron impregnated activated carbon to about room temperature.

10. A filter media for removing arsenic (As) from water comprising:
activated carbon impregnated with iron; and
titanium oxide.

11. The filter media of claim 10 wherein said activated carbon includes coconut shell based carbon.

12. The filter media of claim 11, wherein said activated carbon is screened using ASTM standard sieves with a particle size range of 40×140 US mesh.

13. The filter media of claim 10 wherein said iron-impregnated activated carbon is surface modified using 6% iron(III) chloride (FeCl₃) solution.

14. The filter media of claim 10 wherein said titanium oxide consists of the commercial product Metsorb®.
